(19) United States
(12) Patent Application Publication
(10) Pub. No.: US 2013/0187860 A1
(43) Pub. Date: Jul. 25, 2013

(54) REGULATION OF NAVIGATION SPEED AMONG DISPLAYED ITEMS AND RELATED DEVICES AND METHODS

(71) Applicants: Jenny Fredriksson, Lund (SE); Takamoto Tsuda, Tokyo (JP)

(72) Inventors: Jenny Fredriksson, Lund (SE); Takamoto Tsuda, Tokyo (JP)

(21) Appl. No.: 13/319,409

(22) PCT Filed: Aug. 11, 2010
(86) PCT No.: PCT/IB10/02001

§ 371 Date: Apr. 8, 2013

(51) Int. Cl. G06F 3/0485

(52) U.S. Cl. CPC G06F 3/0485
USPC 345/173

(57) ABSTRACT

An electronic device includes a display screen and a touch sensor operatively associated with the display screen that is configured to detect a location of one or more contact points on a display screen. A controller circuit is configured to control a speed at which information items are scrolled on the display screen responsive to the location of one or more contact points on the display screen such that the speed at which information items are scrolled is changed responsive to detecting one contact point or two spaced-apart contact points by the touch sensor on the display.

### FIELD OF THE INVENTION

The present invention relates to mobile communication terminals and, more particularly, to methods and devices that provide user interfaces for changing navigation among displayed items.

### BACKGROUND

Smart phones and other electronic devices, such as the iPhone®, have been developed that provide users with new and more efficient and/or intuitive ways to control phone functions. Compared with previous approaches of manipulating a joystick/buttons to cause upward or downward movement among a list of displayed items, the iPhone's user interface that allows users to use drag and flick gestures on a touch screen to navigate among a list of displayed items has generally received high consumer praise. One disadvantage of this navigation style is what some users referred to as “pawing”, where a user has to repeatedly use flicking gestures to move through long lists to find desired items.

### SUMMARY OF EMBODIMENTS OF THE INVENTION

In some embodiments of the present invention, an electronic device includes a display screen and a touch sensor operatively associated with the display screen that is configured to detect a location of one or more contact points on a display screen. A controller circuit is configured to control a speed at which information items are scrolled on the display screen responsive to the location of one or more contact points on the display screen such that the speed at which information items are scrolled is changed responsive to detecting one contact point or two spaced-apart contact points by the touch sensor on the display.

In some embodiments, the controller circuit is further configured to determine a distance between two spaced-apart contact points and to further control a speed at which information items are scrolled on the display screen responsive to the distance between the two spaced-apart contact points.

In some embodiments, the controller circuit is configured to initiate a scrolling movement of the information items on the display when the user moves the location of the one or more contact points in a scrolling direction.

In some embodiments, the controller circuit is further configured to change a number of items displayed on the display screen by changing a size of the items displayed when two-spaced apart contact points are detected by the touch sensor on the display. The controller circuit may be further configured to change a number of items displayed by increasing the number of items displayed on the display screen and decreasing a size of the items displayed when two spaced-apart contact points are detected by the touch sensor on the display. The controller circuit may be further configured to change a number of items displayed by decreasing the number of items displayed and increasing a size of the items displayed when only one spaced-apart contact point is detected by the touch sensor on the display. The controller circuit may be further configured to determine when the touch sensor ceases detecting the two spaced-apart contact points and to decrease the number of items displayed by increasing the size of the items displayed when the touch sensor ceases detecting the two spaced-apart contact points.

In some embodiments, the controller circuit is further configured to decrease the speed at which information items are scrolled when one contact point is detected by the touch sensor.

In some embodiments, the controller circuit is configured to display at least two objects on the display screen such that when the user contacts the two objects, the two objects define the two spaced-apart contact points.

In some embodiments, the controller circuit is configured to display the at least two objects responsive to the location of the two spaced-apart contacts such that the speed at which information items are scrolled is increased when a distance between the at least two objects is increased.

In some embodiments, a method of controlling a speed at which information items are scrolled on the display includes detecting a location of one or more contact points on a display and controlling a speed at which information items are scrolled on the display responsive to the location of one or more contact points on the display screen such that the speed at which information items are scrolled is changed responsive to detecting one contact point or two spaced-apart contact points by the touch sensor on the display.

In some embodiments, a distance between two spaced-apart contact points is determined and a speed at which information items are scrolled on the display screen is controlled responsive to the distance between the two spaced-apart contact points.

In some embodiments, a scrolling movement of the information items on the display is initiated when the user moves the location of the one or more contact points in a scrolling direction.

In some embodiments, a number of items displayed on the display screen is changed by changing a size of the items displayed when two-spaced apart contact points are detected by the touch sensor on the display. A number of items displayed may be changed by increasing the number of items displayed on the display screen and decreasing a size of the items displayed when two spaced-apart contact points are detected by the touch sensor on the display. A number of items displayed may be changed by decreasing the number of items displayed and increasing a size of the items displayed when only one spaced-apart contact point is detected by the touch sensor on the display. A number of items displayed may be decreased by increasing the size of the items displayed when two spaced-apart contact points are not detected.

In some embodiments, the speed at which information items are scrolled may be decreased when one contact point is detected by the touch sensor.

In some embodiments, at least two objects may be displayed on the display screen such that when the user contacts the two objects, the two objects defining the two spaced-apart contact points. The at least two objects may be displayed responsive to the location of the two spaced-apart contacts such that the speed at which information items are scrolled is increased when a distance between the at least two objects is increased.

### BRIEF DESCRIPTION OF THE DRAWINGS

The accompanying drawings, which are included to provide a further understanding of the invention and are incorporated in and constitute a part of this application, illustrate certain embodiments of the invention. In the drawings:

FIG. 1 is a block diagram of an electronic device that is configured to operate in accordance with at least some embodiments that are described herein.

FIGS. 2-9 are front views of a display on the electronic device of FIG. 1.

FIG. 10 is a flowchart illustrating operations according to some embodiments that are described herein.

### DETAILED DESCRIPTION OF EMBODIMENTS OF THE INVENTION

The present invention will be described more fully hereinafter with reference to the accompanying figures, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including” when used in this specification, specify the presence of stated features, integers, steps, operations, elements, and/or components, but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to another element, there are no intervening elements present. As used herein, the term “and/or” includes any and all combinations of one or more of the associated listed items and may be abbreviated as “/.”

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure. Although some of the diagrams include arrows on communication paths to show a primary direction of communication, it is to be understood that communication may occur in the opposite direction to the depicted arrows.

Exemplary embodiments are described below with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the functions/acts specified in the block diagrams and/or flowchart block or blocks.

The computer-usable or computer-readable medium may be, for example but not limited to, an electronic, magnetic, optical, electromagnetic, or semiconductor data storage system, apparatus, or device. More specific examples (a non-exhaustive list) of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BlueRay).

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated.

Electronic devices, such as cellular phones and portable music/movie player devices, often have user interfaces that incorporate a touch screen for inputting information and/or making selections. A list of items may be displayed on the screen, and a user may control a scrolling movement of the items by using a scroll bar and/or by moving a contact point with the screen in a direction that scrolling is desired. In accordance with some embodiments, electronic devices can include a touch screen that provides position sensing (e.g., X and Y axis information) that identifies one or more locations where a user is pressing or contacting the screen. In some embodiments, a touch sensor on a touch-sensitive display detects one or more contact points on the display screen, and a controller controls the speed at which information items are scrolled responsive to a number and/or relative location of the contact point(s). For example, the controller may increase the speed at which information items are scrolled if the user inputs two spaced-apart contact points on the display. In some embodiments, a speed at which the information items are scrolled may be controlled responsive to a detected distance between the spaced-apart contact points, e.g., such that the greater the distance between the spaced-apart contact points, the faster the information items are scrolled.

In some embodiments, when the user only inputs one contact point, the speed at which the information items are scrolled is reduced as compared to the speed when the user inputs two contact points. Moreover, other display functions may be controlled based on whether one or two (or more) contact points are detected. For example, a zoom function may be controlled such more or fewer items are displayed by changing the size of the items being displayed responsive to a distance between the contact points.

For purposes of illustration and explanation only, various embodiments of the present invention are described herein in the context of mobile communication terminals (“wireless terminals” or “terminals”) that are configured to communicate through a cellular communication interface, a wireless local area network (WLAN) interface, and/or and Bluetooth wireless interface. It will be understood, however, that the present invention is not limited to such embodiments and may be embodied generally in any type of electronic device with a display that displays items or information and is configured to control a scroll speed or other display function responsive to a number and/or location of user contact points on the display.

FIGS. 1-2 illustrate an exemplary electronic device 100 that may be configured to operate in accordance with at least some of the embodiments that are described herein. Although the electronic device has been illustrated as being a wireless communication terminal, the invention is not limited thereto and may be embodied in any type of device that is configured to sense one or more locations that a user is pressing against the device, and that is configured to control the scrolling speed and/or zooming functions responsive to the sensed location(s). Although various embodiments have been described in the context of the electronic device sensing a touch sensitive contact on the display screen, the device may alternatively or additionally be configured to sense and respond to how much force is applied to a button, joystick, keypad key, or other user interfaces of the device.

Referring to FIG. 1, the exemplary electronic device 100 includes a controller circuit 110 and a display screen 130. The controller circuit 110 may include a general purpose processor circuit and/or a digital signal processor circuit that can execute instructions from a computer readable memory, which may reside therein or may be connected thereto, and/or a logic gate array configured to perform at least some of the operations and methods described herein. The display screen 130 may be a touch sensitive display screen that generates a location signal that indicates a location or locations on the screen that are being touched by the user, and may include a touch sensor 132 that is configured to generate a signal that indicates where the user is contacting the display screen 130. The electronic device 100 further includes a speaker 150, a microphone 160, and a transceiver circuit 120.

A memory circuit 170 can store a music file catalog 172 of digital music files, a picture file catalog 174 or digital pictures, a video file catalog 176 of digital videos, and/or other lists of information (e.g., email in an email folder, individual contact information within a contact list, action item lists) within the device that can be visually displayed on the display screen 130. The controller circuit 110 is configured to play an audio signal via the speaker 150 and/or to display on the display screen 130 a defined number of the items in one or more of the catalogs 172-176, and is configured to operate in accordance with one or more of the embodiments described herein, to control a speed/rate at which information items are scrolled on the display screen 130.

The transceiver circuit 120 may be configured to encode/decode and transmit and receive RF communications according to one or more cellular protocols, which may include, but are not limited to, Global Standard for Mobile (GSM) communication, General Packet Radio Service (GPRS), enhanced data rates for GSM evolution (EDGE), code division multiple access (CDMA), wideband-CDMA, CDMA2000, and/or Universal Mobile Telecommunications System (UMTS), WiMAX, and/or Long Term Evolution (LTE), and/or according to a WLAN (e.g., 802.11) and/or Bluetooth protocol.

As shown in FIGS. 2-9, the electronic device 100 includes a touch sensitive display screen 130 that is configured to identify a location thereon where a user is pressing. As illustrated in FIGS. 2-6, the screen 130 includes two scroll bars 134, 136 and information items displayed in a list 138. As shown in FIG. 3, a single contact from a finger or user input 132T may be used to move the scroll bars 134, 136 in a scrolling direction. The controller circuit 110 (FIG. 1) moves the items in the list 138 on the display 130 in a scrolling direction, which is typically in approximately the same direction that the user input 132T is moving. Although the list 138 is illustrated in FIGS. 2-9 as a plurality of lines for ease of illustration, it should be understood that the list 138 could be any display or information items that are suitable for scrolling, including any text, graphics, video or other items. Accordingly, as used herein, “information items” includes any text, graphics, images or video or other displayed items that are suitable for scrolling.

As shown in FIG. 4, two user inputs 132T may be used to contact the scroll bars 134, 136, and the detected contact points as indicated by the scroll bars 134, 136 may be spaced apart by the user inputs 132T as shown in FIG. 5 and simultaneously moved in a scrolling direction as shown in FIG. 6. Accordingly, the controller circuit 110 is configured to control the speed at which information items in the list 138 are scrolled on the display screen 130 responsive to the number and/or location of one or more contact points from the user input 132T on the display screen 130, e.g., such that the speed at which information items in the list 138 are scrolled is increased or decreased when two spaced-apart contact points from the user input 132T are detected by the touch sensor 132 on the display 130 (as shown in FIGS. 4-6), e.g., instead of only one contact point from a single user input 132T (as shown in FIGS. 2-3).

In some embodiments, the controller circuit 110 is further configured to determine a distance between two spaced-apart contact points from the user inputs 132T and to further control a speed at which information items in the list 138 are scrolled on the display screen responsive to the distance between the two spaced-apart contact points from the user inputs 132T. For example, if the distance between the user inputs 132T (and corresponding contact points on the screen 130) is increased, the speed at which information items in the list 138 are scrolled may be increased (or decreased). The controller circuit 110 may be configured to initiate a scrolling movement of the information items in the list 138 on the display 130 when the user moves the location of the one or more contact points from the user inputs 132T in a scrolling direction. The controller circuit 110 may continue the scrolling motion of the items in the list 138 until another user input is detected indicating that the scrolling motion should be stopped, for example, when the user releases the user inputs 132T and/or stops the movement of the user inputs 132T.

Other display features may be controlled responsive to the number and/or location of the user inputs 132T. The controller circuit 110 may change a number of items displayed in the list 138 on the display screen 130 by changing a size of the items displayed in response to detecting either one contact point from a user input 132T (FIGS. 2-3) or two-spaced apart contact points from two user inputs 132T (FIGS. 4-6). For example, the number of items displayed in the list 138 on the display screen 130 may be increased and a size of the items displayed may be decreased as shown in FIGS. 5-6 when two spaced-apart contact points from the spaced apart user inputs 132T are detected by the touch sensor 132 on the display 130. A number of items displayed in the list 138 may be changed by decreasing the number of items displayed in the list 138 and increasing a size of the items displayed in the list 138 when only one contact point from a user input 132T is detected by the touch sensor 132 on the display 130 as shown in FIG. 2-3 or when the scroll bars 132, 136 are not spaced apart as shown in FIG. 4. The controller circuit 110 may be configured to determine when the touch sensor 132 no longer detects the two spaced-apart contact points, e.g., when a user releases contact with the display or moves the scroll bars 134, 136 back together so that the scroll bars 134 are not spaced apart. When the touch sensor 132 ceases to detect two spaced-apart contact points from the user inputs 132T, the number of items displayed in the list 138 may be decreased by increasing the size of the items displayed. The controller circuit 110 may be configured to decrease the speed at which information items in the list 138 are scrolled when only one contact point from a user input 132T is detected by the touch sensor 132.

Accordingly, the user inputs 132T may be used to control a scrolling speed and/or a zooming function for displaying the information items in the list 138. The detected number of contact points from the user inputs 132T (i.e., one contact, two contacts or three or more contacts) may be used to select a scrolling speed and/or display size (zoom) for the items in the list 138. Thus, the scrolling speed may be increased or decreased responsive to the number of contact points from the user inputs 132T detected on the display 130. The distance between the contact points from the user inputs 132T may also be used to select a scrolling speed and/or display size (zoom) for the items in the list 138 such that the scroll speed and or size of the items in the list 138 may be increased or decreased as the distance between the contact points is increased or decreased.

As illustrated in FIGS. 4-6, two objects or scroll bars 134, 136 are displayed on the display screen 130 such that when the user contacts the scroll bars 134, 136, then the scroll bars 134, 136 define the two spaced-apart contact points of the user inputs 132T. The controller circuit 110 is configured to display the scroll bars responsive to the location of the two spaced-apart contacts from the user inputs 132T such that the speed at which information items in the list 138 are scrolled is changed responsive to the distance between the scroll bars 134, 136. For example, the scroll speed may be increased when a distance between the scroll bars 134, 136 is increased.

Although embodiments according to the present invention are described with respect to the scroll bars 134, 136, it should be understood that any graphically displayed object may be used to define or display the location of the contacts from the user inputs 132T. Moreover, in some embodiments, displayed objects for defining/displaying the location of the user contacts on the display 130 may be omitted. For example, as shown in FIGS. 7-9, the user inputs 132T may contact the display 130 at a contact point 134P (FIG. 7) or at two contact points 134P, 136P (FIGS. 8-9), irrespective of whether a graphical object is displayed indicating a location of the contact points 134P, 136P. The scrolling speed and/or size of the items displayed in the list 138 may be controlled responsive to whether a single contact point 134P is detected (FIG. 7) or if two (or more) contact points 134P, 136P are detected (FIGS. 8-9) and/or a detected distance between the contact points 134P, 136P as described herein without displaying a scroll bar or other graphical object indicating a location of the contact points 134P, 136P.

As illustrated in FIG. 10, a touch sensor as described herein is configured to detect a location of one or more contact points by a user (Block 200). The controller determines how many contact points are detected (Block 202), and selects or changes a scroll speed and/or zoom size responsive to a number of contact points as described herein (Block 204).

Many alterations and modifications may be made by those having ordinary skill in the art in view of the present disclosure and without departing from the spirit and scope of the invention. Various embodiments of the present invention are, therefore, to be read to include not only the combination of elements which are literally set forth but all equivalent elements for performing substantially the same function in substantially the same way to obtain substantially the same result.

In the drawings and specification, there have been disclosed embodiments of the invention and, although specific terms are employed, they are used in a generic and descriptive sense only and not for purposes of limitation, the scope of the invention being set forth in the following claims.

What is claimed:

1. An electronic device comprising:
a display screen;
a touch sensor operatively associated with the display screen that is configured to detect a location of one or more contact points on a display screen; and
a controller circuit that is configured to control a speed at which information items are scrolled on the display screen responsive to the location of the one or more contact points on the display screen such that the speed at which information items are scrolled is changed responsive to detecting one contact point or two spaced-apart contact points by the touch sensor on the display.

2. The electronic device of claim 1, wherein the controller is further configured to determine a distance between two spaced-apart contact points and to further control a speed at which information items are scrolled on the display screen responsive to the distance between the two spaced-apart contact points.

3. The electronic device of claim 1, wherein the controller circuit is configured to initiate a scrolling movement of the information items on the display when the user moves the location of the one or more contact points in a scrolling direction.

4. The electronic device of claim 1, wherein the controller is further configured to change a number of items displayed on the display screen by changing a size of the items displayed when two-spaced apart contact points are detected by the touch sensor on the display.

5. The electronic device of claim 4, wherein the controller is further configured to change a number of items displayed by increasing the number of items displayed on the display screen and decreasing a size of the items displayed when two spaced-apart contact points are detected by the touch sensor on the display.

6. The electronic device of claim 4, wherein the controller is further configured to change a number of items displayed by decreasing the number of items displayed and increasing a size of the items displayed when only one spaced-apart contact point is detected by the touch sensor on the display.

7. The electronic device of claim 4, wherein the controller is further configured to determine when the touch sensor ceases detecting the two spaced-apart contact points and to decrease the number of items displayed by increasing the size of the items displayed when the touch sensor ceases detecting the two spaced-apart contact points.

8. The electronic device of claim 1, wherein the controller is further configured to decrease the speed at which information items are scrolled when one contact point is detected by the touch sensor.

9. The electronic device of claim 1, wherein the controller circuit is configured to display at least two objects on the display screen such that when the user contacts the two objects, the two objects define the two spaced-apart contact points.

10. The electronic device of claim 9, wherein the controller circuit is configured to display the at least two objects responsive to the location of the two spaced-apart contacts such that the speed at which information items are scrolled is increased when a distance between the at least two objects is increased.

11. A method of controlling a speed at which information items are scrolled on the display of an electronic device, the method comprising:
detecting a location of one or more contact points on a display;
controlling a speed at which information items are scrolled on the display responsive to the location of one or more contact points on the display screen such that the speed at which information items are scrolled is changed responsive to detecting one contact point or two spaced-apart contact points by the touch sensor on the display.

12. The method of claim 11, further comprising:
determining a distance between two spaced-apart contact points; and
controlling a speed at which information items are scrolled on the display screen responsive to the distance between the two spaced-apart contact points.

13. The method of claim 11, further comprising initiating a scrolling movement of the information items on the display when the user moves the location of the one or more contact points in a scrolling direction.

14. The method of claim 11, further comprising changing a number of items displayed on the display screen by changing a size of the items displayed when two-spaced apart contact points are detected by the touch sensor on the display.

15. The method of claim 14, further comprising changing a number of items displayed by increasing the number of items displayed on the display screen and decreasing a size of the items displayed when two spaced-apart contact points are detected by the touch sensor on the display.

16. The method of claim 14, further comprising changing a number of items displayed by decreasing the number of items displayed and increasing a size of the items displayed when only one spaced-apart contact point is detected by the touch sensor on the display.

17. The method of claim 14, further comprising decreasing the number of items displayed by increasing the size of the items displayed when two spaced-apart contact points are not detected.

18. The method of claim 11, further comprising decreasing the speed at which information items are scrolled when one contact point is detected by the touch sensor.

19. The method of claim 11, further comprising displaying at least two objects on the display screen such that when the user contacts the two objects, the two objects defining the two spaced-apart contact points.

20. The method of claim 19, further comprising displaying the at least two objects responsive to the location of the two spaced-apart contacts such that the speed at which information items are scrolled is increased when a distance between the at least two objects is increased.
